(19) United States
(12) Patent Application Publication
(10) Pub. No.: US 2017/0020256 A1
(43) Pub. Date: Jan. 26, 2017

(54) MAGNETIC LATCHING SYSTEM

(71) Applicant: Peak Design, San Francisco, CA (US)

(72) Inventors: Robb Jankura, San Francisco, CA (US); Peter Dering, San Francisco, CA (US); Arthur Viger, San Francisco, CA (US)

(21) Appl. No.: 15/215,024

(22) Filed: Jul. 20, 2016

Related U.S. Application Data
(60) Provisional application No. 62/194,667, filed on Jul. 20, 2015.

(51) Int. Cl. A45C 13/10; E05B 65/52; E05C 19/16

(52) U.S. Cl. CPC A45C 13/1069; E05C 19/16; E05B 65/52

(57) ABSTRACT

A magnetic latching system for connecting two components, the magnetic latching system being comprised of a latch assembly and an anchor bar assembly. More specifically, a latch assembly having a latch pull, which contains a latch magnet, and a latch hook, and an anchor bar assembly having an array of anchor bars riveted to a steel plate. The latch magnet attaches to the steel plate to create a lock-free soft closure. Sliding the latch assembly over an anchor bar will engage a hook portion of the latch hook, creating a secure, locked closure. Pulling up on the latch assembly and sliding the latch assembly away from the anchor bar will unlock the magnetic latching system.

### CROSS-REFERENCE TO RELATED APPLICATION

This application claims the benefit of U.S. Provisional Application No. 62/194,667, filed Jul. 20, 2015, titled BAG LATCHING SYSTEM.

### FIELD OF THE DISCLOSURE

The present disclosure relates to a magnetic latching system for connecting two components, the magnetic latching system being comprised of a latch assembly and an anchor bar assembly. More specifically, the latch assembly can have a latch pull, which contains a latch magnet, and a latch hook, and the anchor bar assembly can have an array of anchor bars riveted to a steel plate. The latch magnet attaches to the steel plate to create a lock-free soft closure. Sliding the latch assembly over an anchor bar will engage a hook portion of the latch hook, creating a secure, locked closure. Pulling up on the latch assembly and sliding the latch assembly away from the anchor bar will unlock the magnetic latching system.

### BACKGROUND OF THE INVENTION

There are several types of closure systems on items such as bags, boxes, baskets, containers, luggage, belts, clothing, footwear, and headwear today. These various closure systems include buttons, zippers, magnets, clips, etc. with each design having advantages and disadvantages. When considering which type of closure system design to use, there are three critical attributes to keep in mind: flexibility, security, and ease of use.

Traditionally, soft goods, such as bags, are flexible and can change shape dramatically depending on the use case. For example, a bag that is mostly empty will change shape more frequently during use than a bag that is full. Therefore, for flexible goods, a good closure system should also be flexible enough to accommodate changes in the shape and size of the item being closed during use.

Another critical attribute for a closure system to have is security: once a closure system is closed, it should stay closed. A secure closure system should prevent goods that are held inside of an item from finding their way outside of the item. For example, a closure system on a bag should prevent goods that are inside of the bag from inadvertently falling out of the bag.

Lastly, users have little patience for cumbersome closure systems. For example, bags typically need to be accessed often and, thus, the process of accessing must be quick and easy. Most systems that are highly secure are too cumbersome to use repeatedly and result in lower security, as the user will often forego the complete process of closure in exchange for increased convenience.

Therefore, a closure system is needed that is flexible enough to close items that vary in fill levels, is secure when enacted, and is efficient and easy to use.

### SUMMARY OF THE INVENTION

The disclosed magnetic latching system achieves the combination of flexibility, security, and ease of use by using a magnetic bar and hook system. The magnetic latching system can adjust to a range of bag fill levels by using an array of anchor bars with which a latch assembly can engage. In a preferred embodiment, the magnetic latching system uses magnetic force to lock a hook portion onto an anchor bar, thereby connecting two components together. More specifically, on bag closure, the magnetic force attracts the latch assembly to the anchor bar array. The magnetic latching system then fully locks when the hook portion is pulled over the anchor bar and a locking member keeps the anchor bar in place. Once locked, user action is required for release. More specifically, the latch pull is pulled upward and outward, and the remainder of the magnetic latching system can release. Closure and release can be completed with one hand, thereby enabling efficient and easy use.

### BRIEF DESCRIPTION OF THE DRAWINGS

FIG. 1 is a top right perspective view of the magnetic latching system in a locked position according to one embodiment of the present invention.

FIG. 2 is an exploded view of the disclosed magnetic latching system according to one embodiment of the present invention.

FIG. 3 is a right side view of the latch assembly in a locked position according to one embodiment of the present invention.

FIG. 4 is a right side view of the latch assembly in an open position according to one embodiment of the present invention.

FIG. 5 is a top right perspective view of the latch assembly according to one embodiment of the present invention.

FIG. 6 is a bottom right perspective view of the latch assembly according to one embodiment of the present invention.

FIG. 7 is a front view of the latch assembly according to one embodiment of the present invention.

FIG. 8 is a top cross-sectional view of the latch assembly taken from the line 8-8 in FIG. 7 according to one embodiment of the present invention.

FIG. 9 is a bottom right perspective view of the latch pull and magnet according to one embodiment of the present invention.

FIG. 10 is a bottom view of the latch pull and magnet according to one embodiment of the present invention.

FIG. 11 is a right side cross-sectional view of the latch pull and magnet taken from the line 11-11 in FIG. 10 according to one embodiment of the present invention; the left side cross-sectional view is a mirror image of the right side cross-sectional view.

FIG. 12 is a right side cross-sectional view of the latch pull and magnet taken from the line 12-12 in FIG. 10 according to one embodiment of the present invention; the left side cross-sectional view is a mirror image of the right side cross-sectional view.

FIG. 13 is a left side view of the latch pull according to one embodiment of the present invention.

FIG. 14 is a top view of the latch pull according to one embodiment of the present invention.

FIG. 15 is a front view of the latch pull according to one embodiment of the present invention.

FIG. 16 is a top right perspective view of the latch pull according to one embodiment of the present invention.

FIG. 17 is a perspective view of the latch magnet illustrating the direction of magnetization according to one embodiment of the present invention.

FIG. 18 is a side view of the latch hinge pin before crimping according to one embodiment of the present invention.

FIG. 19 is a side view of the latch hinge pin after crimping, and in its final form, according to one embodiment of the present invention.

FIG. 20 is a perspective view of the latch hinge pin according to one embodiment of the present invention.

FIG. 21 is a bottom view of the latch hook according to one embodiment of the present invention.

FIG. 22 is a ride side cross-sectional view of the latch hook taken from the line 22-22 in FIG. 21 according to one embodiment of the present invention; the left side cross-sectional view is a mirror image of the right side cross-sectional view.

FIG. 23 is a ride side cross-sectional view of the latch hook taken from the line 23-23 in FIG. 21 according to one embodiment of the present invention; the left side cross-sectional view is a mirror image of the right side cross-sectional view.

FIG. 24 is a front view of the latch hook according to one embodiment of the present invention.

FIG. 25 is a top view of the latch hook according to one embodiment of the present invention.

FIG. 26 is a left side view of the latch hook according to one embodiment of the present invention.

FIG. 27 is a top right perspective view of the latch hook according to one embodiment of the present invention.

FIG. 28 is a top perspective view of the anchor bar according to one embodiment of the present invention.

FIG. 29 is a bottom view of the anchor bar according to one embodiment of the present invention.

FIG. 30 is a front view of the anchor bar according to one embodiment of the present invention.

FIG. 31 is top view of the anchor bar according to one embodiment of the present invention.

FIG. 32 is a front cross-sectional view of the latch taken from the line 32-32 in FIG. 31 according to one embodiment of the present invention.

FIG. 33 is a side view of a rivet after installation according to one embodiment of the present invention.

FIG. 34 is a perspective view of a rivet according to one embodiment of the present invention.

FIG. 35 is top view of a rivet according to one embodiment of the present invention.

FIG. 36 is a side cross-sectional view of the rivet taken from the line 36-36 in FIG. 35 according to one embodiment of the present invention.

FIG. 37 is a right side view of the magnetic latching system in an unlocked position according to one embodiment of the present invention.

FIG. 38 is a right side view of the magnetic latching system in a mid-locked position according to one embodiment of the present invention.

FIG. 39 is a right side view of the magnetic latching system in a locked position according to one embodiment of the present invention.

FIG. 40 is a right side view of the magnetic latching system in an unlocking position according to one embodiment of the present invention.

### DETAILED DESCRIPTION

The present disclosure relates to a magnetic latching system that is used to easily and efficiently lock items shut by taking two components of the system, each one being attached to one part of the item, and connecting them to each other. For example, with a messenger bag, the first component can be attached to a bag flap and the second component can be attached the main body of the bag. Therefore, when the first component connects to the second component, the bag flap is connected, and securely locked, to the main body of the bag. Various embodiments of the magnetic latching system will be described in detail with reference to the drawings, wherein like reference numerals represent like parts and assemblies throughout the several views. Reference to various embodiments does not limit the scope of the magnetic latching system disclosed herein. Further, although the invention is described in connection with closing and locking bags, the system and method disclosed herein can also be applied to items other than bags, including boxes, baskets, containers, luggage, belts, clothing, footwear, headwear, such as hats and helmets, and other items that can be closed and locked. Additionally, any examples set forth in this specification are not intended to be limiting and merely set forth some of the many possible embodiments for the magnetic latching system. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

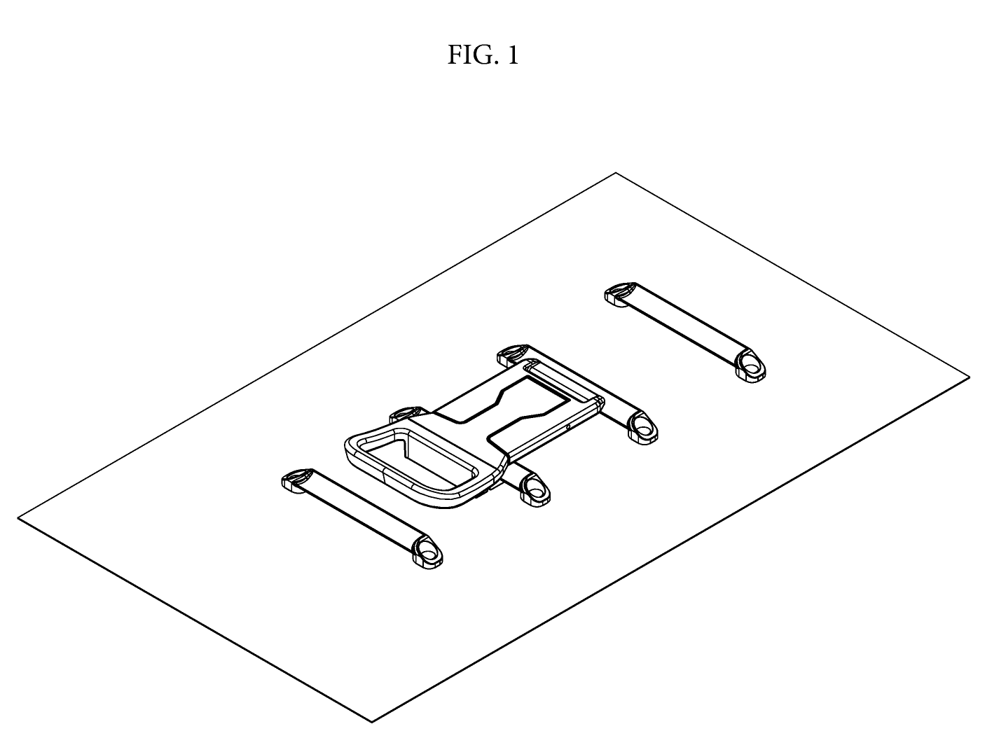

The disclosed magnetic latching system, illustrated in FIG. 1, is a closure system that achieves the combination of flexibility, security, and ease of use by using a magnetic bar and hook system to easily and efficiently lock two items together. More specifically, the magnetic latching system can be comprised of a latch assembly and an anchor bar assembly, wherein the latch assembly is comprised of a latch pull 202, which contains a latch magnet 204, and a latch hook 208, and the anchor bar assembly is comprised of an array of anchor bars 212 in proximity to (for example, riveted to) a rigid back plate 214 that acts as an attachment point and, in some embodiments, is made of steel. In a preferred embodiment, the latch magnet 204 attaches to the rigid back plate 214 to create a lock-free soft closure. More specifically, on bag closure, the magnetic force attracts the latch assembly to the anchor bar array. Sliding the latch assembly over an anchor bar 212 will then engage a hook portion 302 of the latch hook 208, creating a secure, locked, hard closure. More specifically, the magnetic latching system can use a latch hook 208 that latches on to an anchor bar 212, a locking member 308 on a latch pull 202 that secures the latch hook 208 to the anchor bar 212, and a latch magnet 204 attached to a latch pull 202 for the purpose of creating a lock-free soft closure between the latch assembly and the anchor bar assembly. Once locked in a hard closure, user action is required for release. Pulling up on the latch assembly and sliding the latch assembly away from the anchor bar 212 can unlock and release the magnetic latching system. Closure and release can be completed with one hand. Having an array of anchor bars 212 allows the latch assembly several connection location options. For example, with a messenger bag, the magnetic latching system can adjust to a range of bag fill levels by allowing the latch assembly to engage with any of anchor bars 212 in the array.

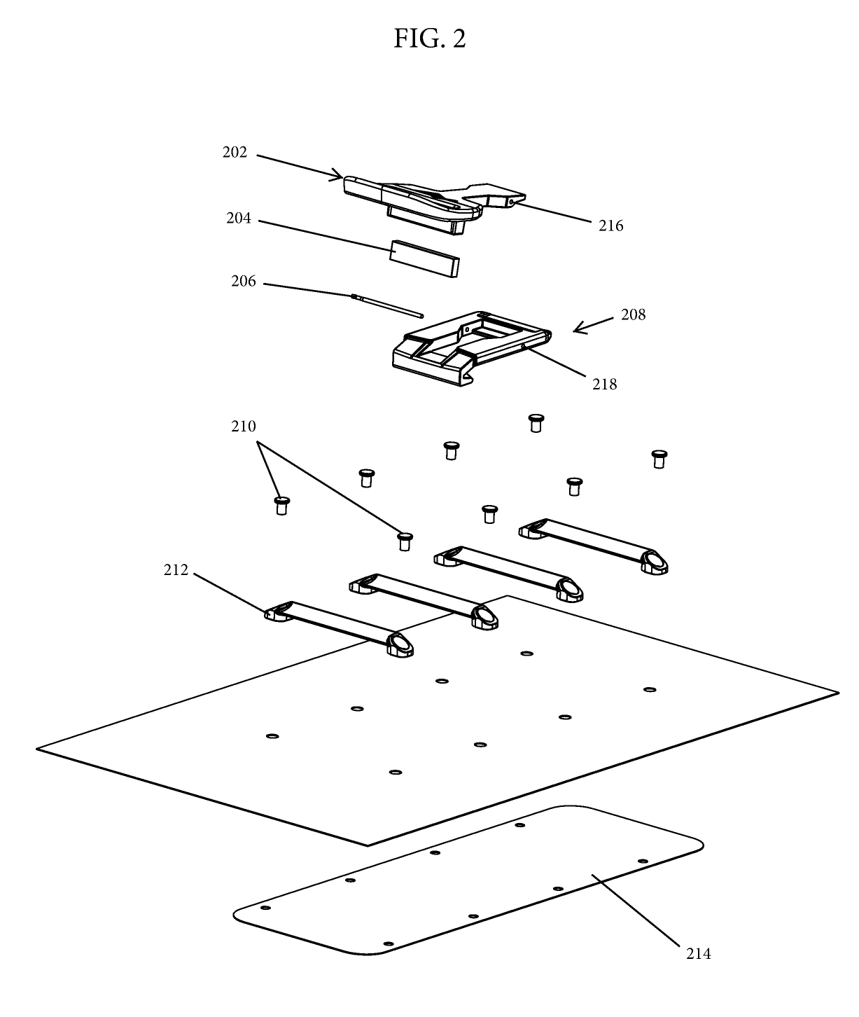

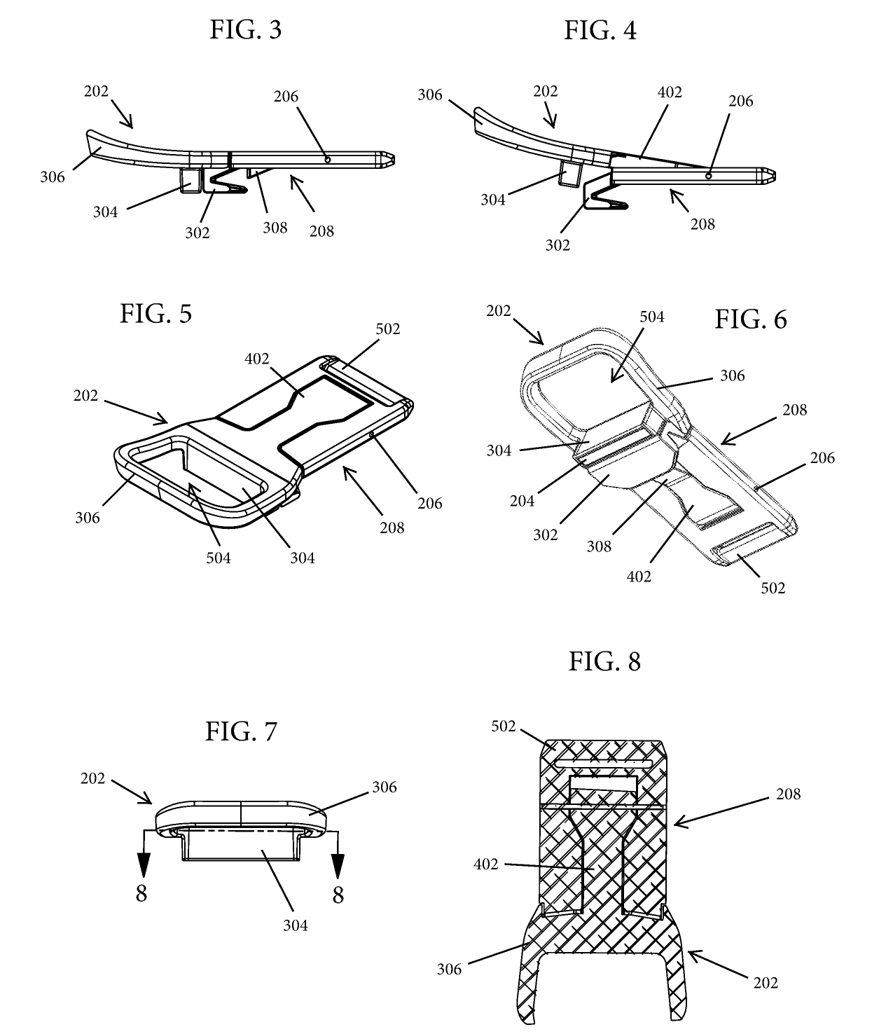

As illustrated in FIG. 2, various embodiments of the magnetic latching system can include a number of components including, but not limited to, a latch pull 202, a latch magnet 204, a latch hinge pin 206, a latch hook 208, a plurality of rivets 210, an anchor bar 212, and a rigid back plate 214. The latch pull 202, the latch magnet 204, the latch hinge pin 206, and the latch hook 208 generally make up the latch assembly, illustrated in FIGS. 3-8, and are removably attached to the anchor bar 212 when in the locked, or closed, position. The rivets 210 attach the anchor bar 212 to the rigid back plate 214 to provide a secured anchor to which the hook portion 302 of the latch hook 208 can attach. When the magnetic latching system is used on a bag, such as a messenger bag, the latch assembly can be attached to a bag flap, and the rivets 210, anchor bar 212, and rigid back plate 214 can be attached to the main body of the bag. Therefore, the latch assembly on the bag flap can hook onto the anchor bar 212 on the main body of the bag. The latch assembly is generally made from die cast aluminum, but could also be made from other rigid materials such as, but not limited to, plastic, diecast zinc, stamped steel, or possibly machined aluminum.

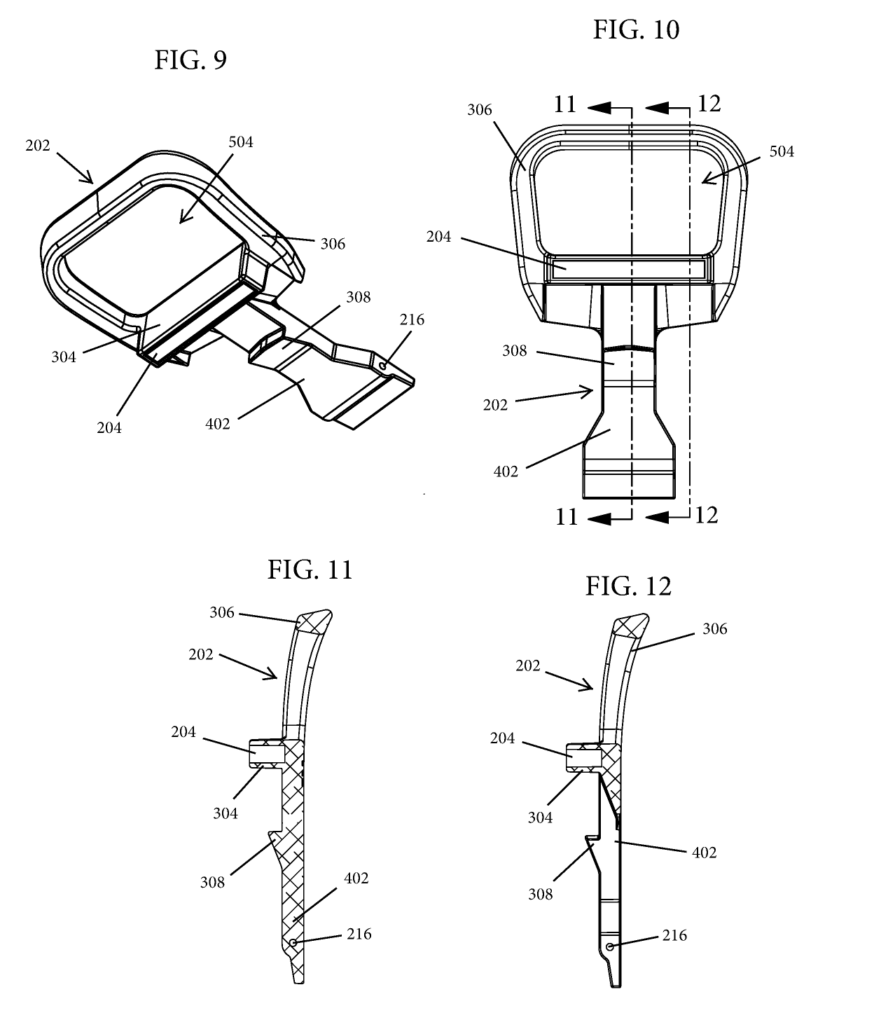

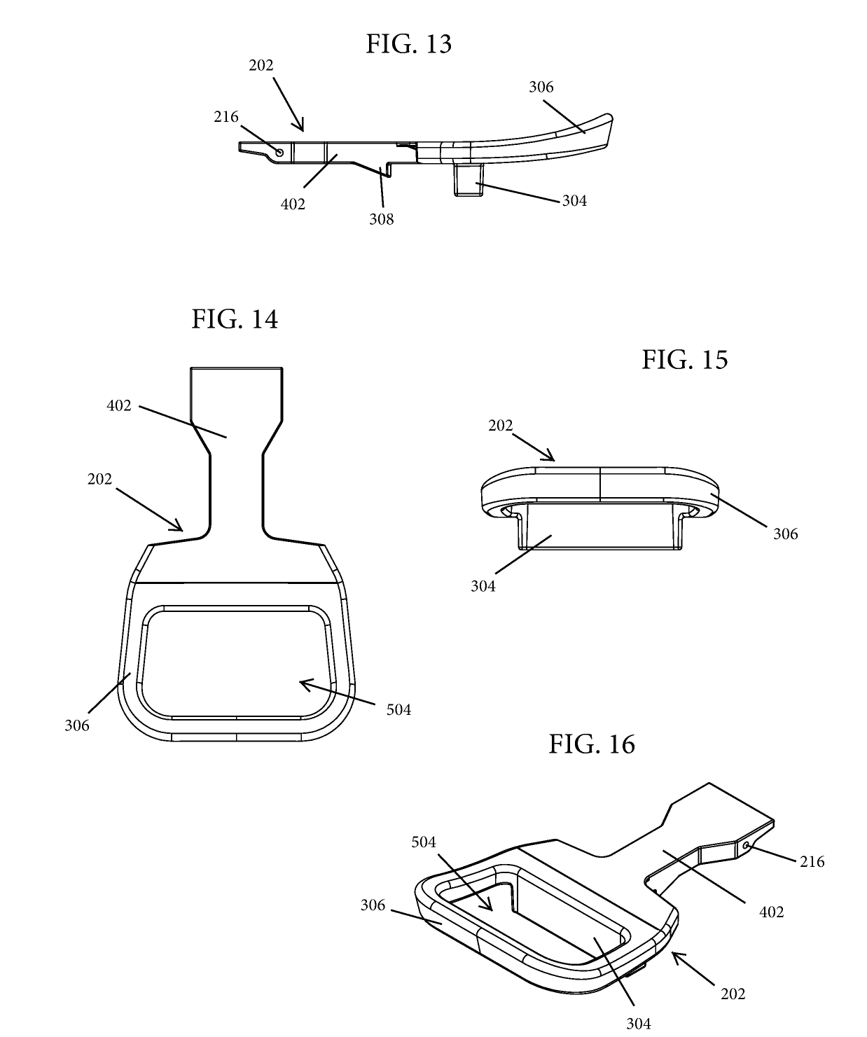

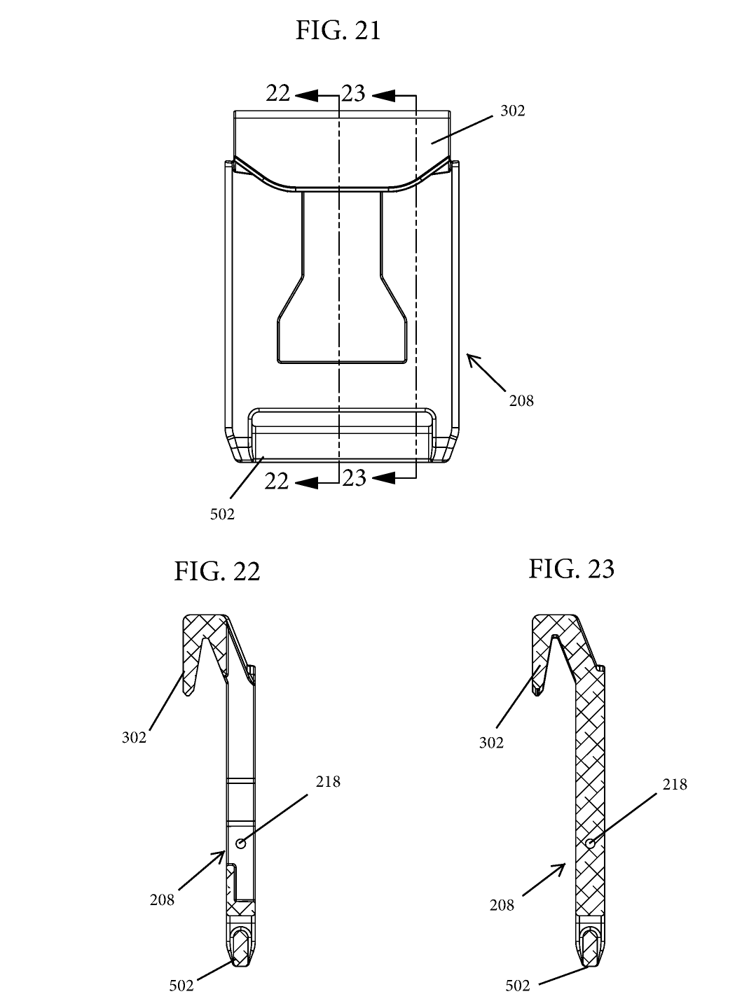

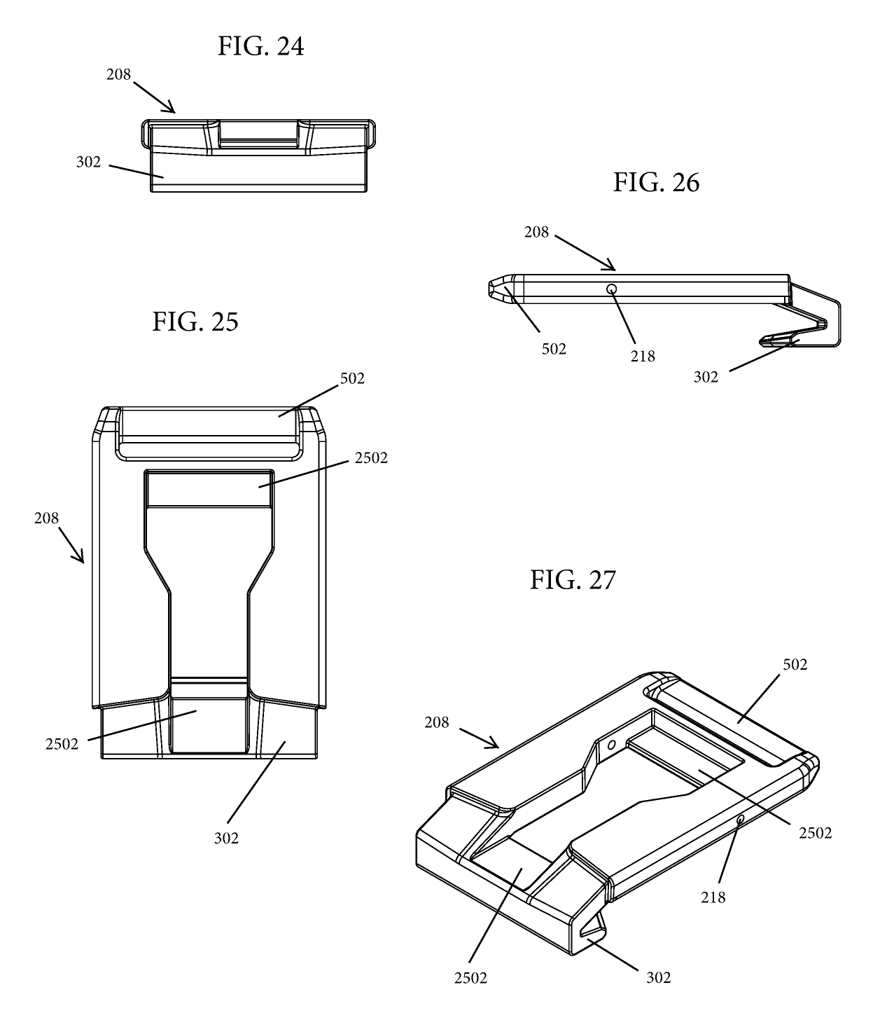

The latch pull 202, illustrated in FIGS. 9-16, can have several components including, but not limited to, a housing 304 for the latch magnet 204, a head portion 306 with a gap or hollow opening 504, a tail portion 402, a locking member 308, and a latch pull opening 216 for receiving the latch hinge pin 206. The latch hook 208, illustrated in FIGS. 21-27, can have several components including, but not limited to, a hook portion 302 on its proximal end, a latch hook bar 502 on its distal end, one or more protrusions 2502, and a latch hook opening 218 for receiving the latch hinge pin 206.

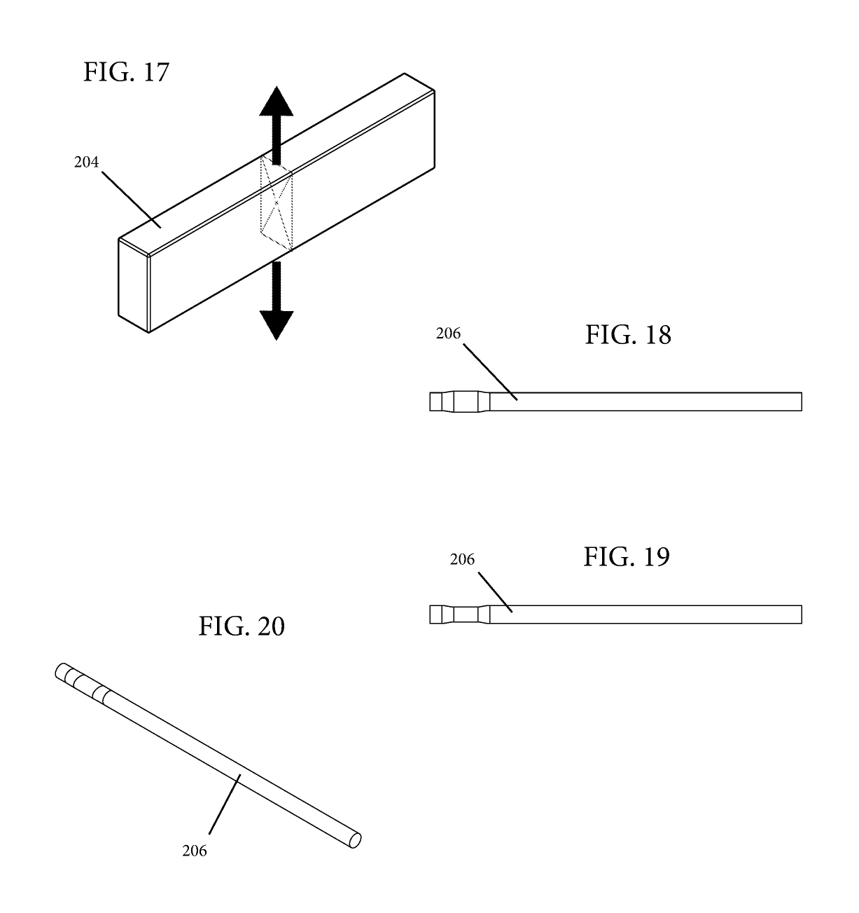

In some embodiments, the latch magnet 204, illustrated in FIG. 17, has the shape of a rectangular prism. In other embodiments, the latch magnet 204 can take a non-rectangular prism shape and/or can be comprised of two or more magnets. For example, a plurality of magnets may comprise the latch magnet 204 instead of one, larger magnet. The latch magnet 204 can have the approximate dimensions of 27.50 mm long, 6.50 mm tall, and 3 mm wide. The latch magnet 204 can be located on the bottom portion of the latch assembly, as illustrated in FIG. 6, and can contribute to a secure lock by being magnetically attracted to the rigid back plate 214. Therefore, the direction of magnetization of the latch magnet 204 is important and, in a preferred embodiment, will be oriented out and away from the center of the magnet 204, as illustrated by the arrows in FIG. 17. As described briefly above, the latch magnet 204 enables a lock-free soft closure because of its attraction to the rigid back plate 214.

In some embodiments, the latch magnet 204 is secured in a housing 304. In other embodiments, the latch magnet 204 is attached directly to the bottom portion of the latch assembly and no housing 304 exists. For embodiments wherein a plurality of magnets comprises the latch magnet 204, each of the plurality of magnets may have their own housing, the housing 304 may be compartmentalized, or the plurality of magnets may attach directly to the bottom portion of the latch assembly and have no housing 304.

The housing 304 for the latch magnet 204 can be located on the bottom of the latch pull 202. In a preferred embodiment, the latch magnet 204 is located on the bottom of the head portion 306 of the latch pull 202, as illustrated in FIGS. 9, 11-13, and 15-16. The housing 304 can be hollow or can have a hollow portion and can fully encompass the top face and the four side faces of the latch magnet 204, leaving the bottom face of the latch magnet 204 exposed to interact with the rigid back plate 214. However, the latch magnet 204 may, in some embodiments, be entirely encompassed within the housing 304 such that no face of the latch magnet 204 is exposed.

In a preferred embodiment, the bottom, exposed face of the latch magnet 204 is flush with the bottom surface of the housing 304. Therefore, magnetic attraction of the magnetic portion of the latch assembly can be limited to ferromagnetic items that are facing the bottom or base of the latch assembly. In an alternative embodiment, the bottom face of the latch magnet 204 is not flush with the bottom surface of the housing 304 and is, instead, either protruding out from the bottom surface of the housing 304 or recessed into the housing 304.

In a preferred embodiment, the housing 304 can have the approximate dimensions of 30 mm long, 6 mm tall, and 5 mm wide, with each of the side walls being between approximately 0.88 and 1.0 mm thick and with the hollow portion of the housing 304 extending into the head portion 306 of the latch pull 202 to allow for the bottom face of the latch magnet 204 to be flush with the bottom surface of the housing 304.

As described above, some embodiments of the head portion 306 of the latch pull 202 can have a gap or a hollow opening 504, as illustrated in FIGS. 9-10, 14, and 16, to enable a user to hook a finger through the latch pull 202 and detach the latch assembly from the anchor bar 212. In other embodiments, instead of a gap or hollow opening 504, the head portion 306 can be solid. However, a solid head portion 306, while it can be uniformly solid and flat, can, in some embodiments, have a thinner portion towards the center such as a cavity or depression. This thinner portion can be located in a central position between the top and bottom. Alternatively, the bottom of the thinner portion can be flush with the bottom of the head portion 306 and the top of the thinner portion can be the portion that is depressed. This cavity or depression can enable a user to have a better grasp on the head portion 306 of the latch pull 202. In embodiments with a gap or hollow opening 504, the gap or hollow opening 504 can be of various sizes and shapes, but is ideally big enough for at least the tip of a user's finger to fit through.

In a preferred embodiment, the front of the head portion 306 contains the gap or hollow opening 504 and the back or rear of the head portion 306 connects to the front of the tail portion 402. The tail portion 402 can be entirely contained within the latch hook 208, as illustrated in FIGS. 5-6, and the back of the tail portion 402 can be located near the back of the latch hook 208.

The latch hinge pin 206, illustrated in FIGS. 18-20, can secure the back of the tail portion 402 to the back of the latch hook 208 using a crimping feature. For example, FIG. 18 illustrates one embodiment of the latch hinge pin 206 prior to crimping and FIG. 19 illustrates one embodiment of the latch hinge pin 206 after crimping and in its final form when it has been secured within the latch pull opening 216 and a latch hook opening 218. FIG. 20 is a perspective view of the latch hinge pin 206. The latch hinge pin 206 can enable the latch pull 202 to rotate away from the latch hook 208 without separating, as illustrated in FIGS. 4, and 40. In a preferred embodiment, the latch hinge pin 206 will not protrude from either side of the latch assembly. Therefore, in one embodiment, if the width of the latch assembly is around 32.40 mm, the width of the latch hinge pin 206 will be approximately 31 mm to ensure it does not protrude.

The locking member 308 on the latch pull 202 can be located on, and centered on, the front part of the bottom of the tail portion 402 of the latch pull 202, as illustrated in FIGS. 9-13, and can be roughly wedge-shaped with the locking member 308 being thickest at its front and tapering as it proceeds towards the back of the latch pull 202. The locking member 308 can protrude out from the bottom of the latch pull 202 approximately 2.50 mm. The locking member 308 can be spaced from the housing 304 such that the anchor bar 212 is able to fit snuggly between the housing 304 and the locking member 308, as illustrated in FIG. 39-40. For example, the space between the housing 304 and the locking member 308 can be approximately 11-12 mm (for example, 11.76 mm) and the anchor bar 212 can be approximately 7 mm wide.

In some embodiments, the hook portion 302 of the latch hook 208 can also fit between the housing 304 and the locking member 308, as illustrated in FIGS. 3 and 37-40, wherein the hook portion 302 is approximately 11.25 inches, and wherein the anchor bar 212 can fit entirely within the hook portion 302. Therefore, when the magnetic latching system is in the locked position, the latch hook 208 can hook onto the front of the anchor bar 212 via the hook portion 302, the latch magnet 204, located in front of the hook portion 302, can be magnetically attached to the rigid back plate 214 located underneath the anchor bar 212, and the locking member 308, located behind the hook portion 302, can hook over the back of the anchor bar 212 to prevent the latch assembly from sliding off the front of the anchor bar 212.

The latch hook 208, illustrated in FIGS. 21-27, can be made of aluminum alloy. It can be approximately 32-33 mm wide and 48-49 mm long. The height of the main body of the latch hook 208 can be approximately 4 mm. The distance from the bottom of the hook to the top of the main body can be approximately 10 mm. The latch hook 208 can have a generally rectangular-shaped main body, a hole or cavity in the main body sized to receive the tail portion 402 of the latch pull 202, as illustrated in FIGS. 5-6, and a hook portion 302 that extends off of the front and curves under the main body, as illustrated in FIGS. 4, 22-23, and 26-27.

In a preferred embodiment, the main body of the latch hook 208 and the main body of the latch pull 202 are flush with each other when they are in the closed, or locked, position, as illustrated in FIG. 3, and the bottom of the hook portion 302 can be flush with the bottom of the housing 304. As described above, the latch hook 208 attaches to the latch pull 202 through the use of a latch hinge pin 206 that penetrates through the latch pull opening 216 and the latch hook opening 218, which are in line with each other.

The back end of the main body of the latch hook 208 can have a latch hook bar 502 for a strap to attach to, as illustrated in FIGS. 1, 5-6, 8, 21, 25, and 27. In some embodiments, the strap is elastic. The end of the strap that does not attach to the latch hook bar 502 can be permanently affixed to a bag that the magnetic latching system is being used on. Therefore, the latch assembly can be affixed to the bag via the strap, which is attached to the latch hook bar 502. For added support of the latch pull 202 when it is resting inside the latch hook 208, or to keep the latch pull 202 flush with, or above, the latch hook 208, the latch hook cavity may have a protrusion 2502 for the latch pull 202 to rest against, as illustrated in FIGS. 25 and 27. The protrusion 2502 may be toward the front of the latch hook 208, the back of the latch hook 208, or both.

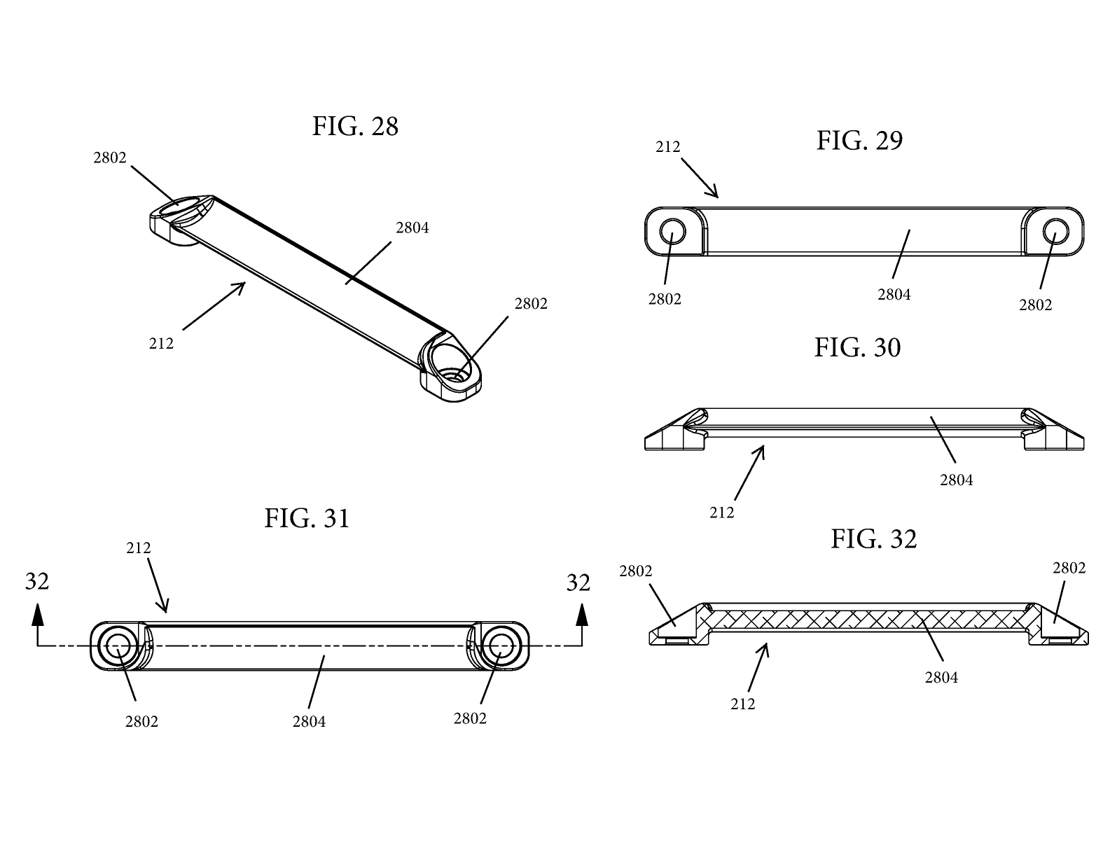

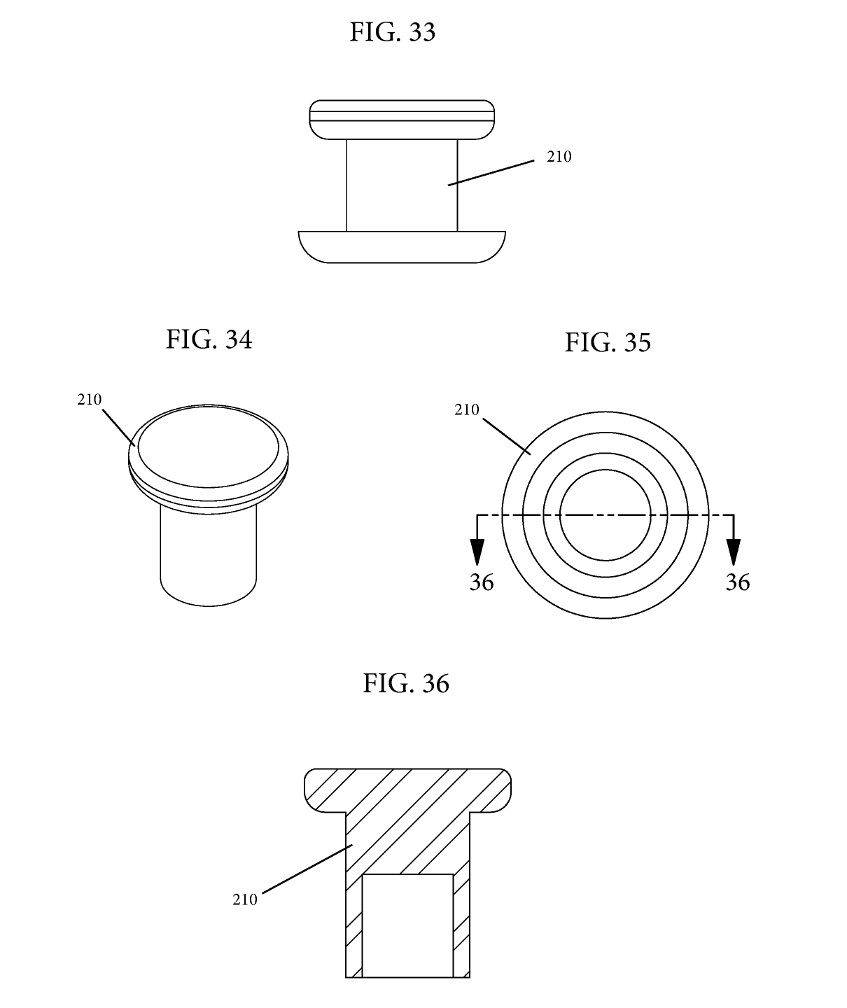

As described above, the anchor bar 212, illustrated in FIGS. 28-32, can be an attachment point for the latch assembly to lock to. In some embodiments, other types of anchors or attachment points are used. For example, the anchor, instead of being a bar, could be a slot, a housing with an opening, or any other solid structure that can receive the latch assembly. Each anchor bar 212 can, in some embodiments, be made of aluminum alloy. In an embodiment where the magnetic latching system is used on a bag, the magnetic latching system preferably has four anchor bars 212, which enable the bag to securely lock regardless of the bag's fill level. The anchor bars 212 can be held to the rigid back plate 214 using two rivets 210, illustrated in FIGS. 33-36, attached to the ends of each roughly rectangular anchor bar 212. Therefore, each anchor bar 212 can have an opening, or rivet attachment point 2802, on each of its ends.

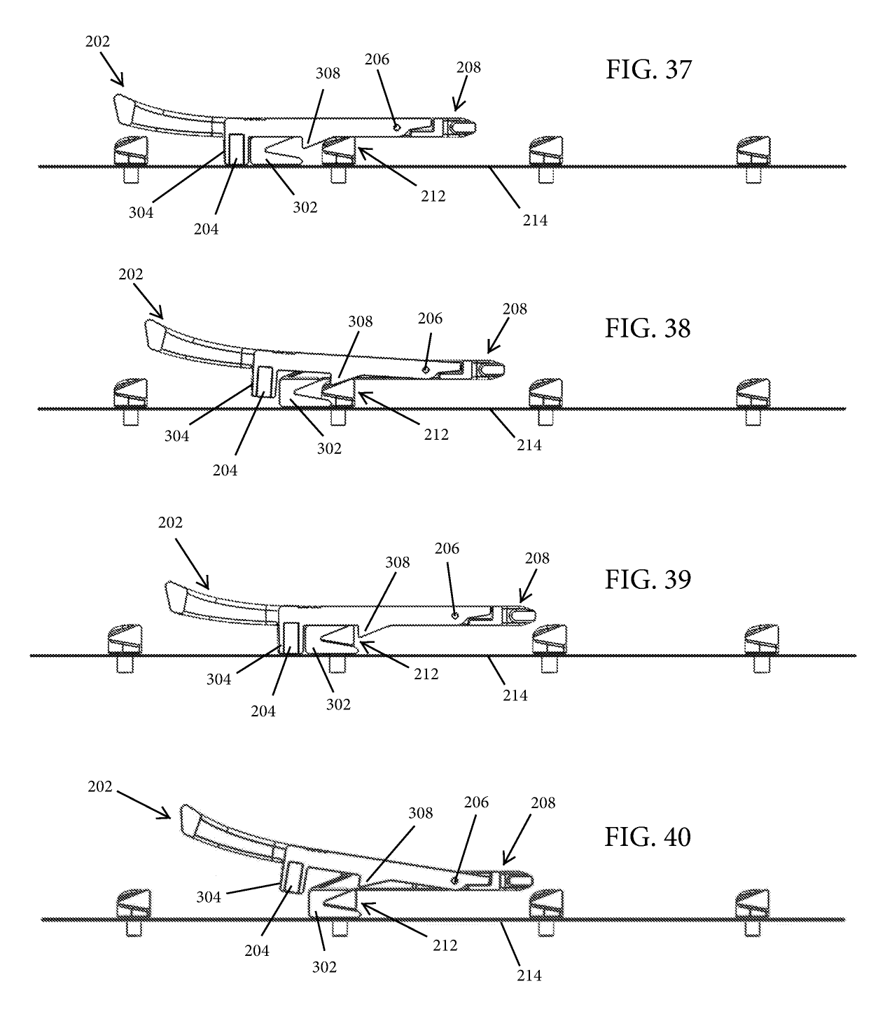

In some embodiments, the bridge 2804 of the anchor bar 212 can be slightly elevated to enable a portion of the hook portion 302 of the latch hook 208 to slide underneath it, as illustrated in FIGS. 37-40. Additionally the bridge 2804 of the anchor bar 212 can have a wedge shape, with the front part of the bridge 2804 being narrower than the back part, as illustrated in FIGS. 30 and 37-40. This shape provides a more secure fit due to the anchor bar's narrow, front face being wedged into the hook portion 302 and its flat, wider back face being held in place by the locking member 308, which may also be wedge-shaped, as described above. The narrow portion can be pointed or it can be rounded. The anchor bar 212 can have the approximate dimensions of 63 mm long, 7 mm wide at its widest point, and 6 mm tall. The space between the center of each rivet attachment point 2802 can be approximately 55 mm to match the spacing on the rigid back plate 214.

In some embodiments, the rivets 210 can be made of aluminum alloy. As described above, each anchor bar 212 can be secured to the rigid back plate 214 by inserting two rivets 210 into the anchor bar 212, one on each end of the anchor bar 212 in the rivet attachment points 2802. FIG. 33 illustrates an example rivet 210 after it has been secured to the rigid back plate 214. FIG. 34 illustrates an example rivet 210 before it has been secured to the rigid back plate 214. FIG. 35 illustrates a top view of the rivet 210 and FIG. 36 illustrates a cross section view of a preferred rivet 210 used in the disclosed invention.

In a preferred embodiment, the rigid back plate 214 is ferromagnetic to enable the latch magnet 204 to be magnetically attracted to it and to operate as an attachment point for the anchor bar 212. For example, the rigid back plate 214, in some embodiments, can be made of steel such as, but not limited to, galvanized ferritic steel. In a preferred embodiment, the rigid back plate 214 is roughly rectangular and can be approximately 0.3 mm thick, 175 mm long, and 65 mm wide. However, the rigid back plate 214 can be any shape such as, but not limited to, a strip or plurality of strips, a bar or plurality of bars, a square, a circle, an oval, a triangle, a trapezoid, etc. In some embodiments, the rigid back plate 214 may even be a series of rigid attachment points for the anchor bar 212.

In a preferred embodiment, the magnetic latching system has four anchor bars 212 to allow the bag to lock securely regardless of how full it is. The anchor bars 212 can be parallel to, and in line with, each other, as illustrated in FIGS. 1-2 and 37-40. Therefore, in a preferred embodiment, because each anchor bar 212 is held to the rigid back plate 214 using two rivets 210, the rigid back plate 214 has eight opening for the rivets 210. Each opening can be spaced approximately 45 mm from the next opening on the same side, approximately 55 mm from the opening it is paired with, and approximately 5 mm from the edge of the rigid back plate 214. The openings on the ends of the rigid back plate 214 can be approximately 20 mm from the end of the rigid back plate 214.

As illustrated in FIGS. 37-40, the magnetic latching system easily and securely locks a bag closed. The latch assembly is automatically drawn to the anchor bars 212 by the attraction of the latch magnet 204 located at the base of the latch assembly to the ferromagnetic rigid back plate 214 that the anchor bars 212 are attached to. Once the latch assembly is magnetically and releasably adhered to the rigid back plate 214, as illustrated in FIG. 37, the latch assembly can slide toward an anchor bar 212, and the hook portion 302 of the latch hook 208 can slide or wrap around and surround at least a portion of the bridge 2804 so that the interior portion of the hook portion 302 is in contact with the bridge 2804 of the anchor bar 212. In some embodiments, the hook portion 302 envelops at least a portion of the bridge 2804 of the anchor bar 212 due to the bridge 2804 being elevated up off of the rigid back plate 214. As the hook portion 302 slides around the bridge 2804, the locking member 308 is lifted up on top of the bridge 2804, as illustrated in FIG. 38. Once the locking member 308 clears the bridge 2804, the magnetic draw of the latch magnet 204 causes the locking member 308 to move back down into place, locking the anchor bar 212 within the hook portion 302 and between the housing 304 and the locking member 308, as illustrated in FIG. 39. Because the anchor bar 212 is attached on its ends to the rigid back plate 214 and is wedged within the hook portion 302 and between the housing 304 and the locking member 308, the magnetic latching system is securely locked.

In some embodiments, a spring can be used in combination with a magnet to activate the magnetic latching system. For example, one embodiment of the magnetic latching system could use a spring, rather than the latch magnet 204, to pull or push the locking member 308 down when it slides past the anchor bar 212. More specifically, a magnet may still be used to hold the magnetic latching system down once it is in place, but a spring can be used to engage the locking member 308 by pulling or pushing the locking member 308 down into place and placing the anchor bar 212 within the hook portion 302 and between the housing 304 and locking member 308.

To release the magnetic latching system, the latch magnet 204 can be pulled up off of the rigid back plate 214, and the locking member 308 can be pulled far enough up so that it clears the bridge 2804 of the anchor bar 212, as illustrated in FIG. 40. This can be accomplished by pulling up on the head portion 306 of the latch pull 202. When the locking member 308 clears the height of the anchor bar 212, the hook portion 302 can slide away and release the anchor bar 212, effectively unlocking the magnetic latching system and allowing the latch assembly to separate from the anchor bar 212. Therefore, locking and unlocking the magnetic latching system takes minimal effort, yet enables the bag to be kept securely locked shut without accidentally opening. As described above, and illustrated in FIGS. 1-2, and 37-40, the magnetic latching system can have several anchor bars 212 to enable a bag to be tightly closed regardless of how empty or full the bag is.

What is claimed is:

1. A magnetic latching system comprising:
a latch pull having a housing and a locking member;
a latch magnet stored within the latch pull housing;
a latch hook having a hook portion;
an anchor; and
a ferromagnetic attachment point for the anchor that is in proximity to the anchor;
wherein:
the latch magnet is configured to magnetically draw and releasably adhere to the latch pull and the latch hook to the ferromagnetic attachment point;
an interior portion of the hook portion of the latch hook engages with the anchor; and
the latch pull locking member prevents the latch pull and the latch hook from disengaging from the anchor.

2. The magnetic latching system of claim 1, wherein the ferromagnetic attachment point is a back plate.

3. The magnetic latching system of claim 2, further comprising a plurality of rivets attaching the anchor to the back plate.

4. The magnetic latching system of claim 1, wherein the magnetic latching system is incorporated onto a bag.

5. The magnetic latching system of claim 1, wherein the anchor is an anchor bar.

6. The magnetic latching system of claim 5, further comprising a plurality of anchor bars.

7. The magnetic latching system of claim 6, wherein the anchor bars are parallel to each other.

8. The magnetic latching system of claim 1, further comprising a latch hook bar on a distal end of the latch hook.

9. The magnetic latching system of claim 8, further comprising a strap attached to the latch hook bar.

10. The magnetic latching system of claim 9, wherein the strap is elastic.

11. The magnetic latching system of claim 10, wherein the strap is connected to a portion of a bag.

12. The magnetic latching system of claim 1, further comprising a latch hinge pin connecting the latch pull to the latch hook.

13. A magnetic latching system comprising:
a latch assembly having a latch pull, a latch magnet stored within a housing of the latch pull, a latch hook having a hook portion, and a locking member;
at least one anchor bar configured to be positioned between the hook portion and the locking member; and
a steel back plate to which at least a portion of the latch assembly is releasably adhered and the at least one anchor bar is fixedly attached.

14. The magnetic latching system of claim 13, wherein the latch pull is located on a first end of the latch assembly.

15. The magnetic latching system of claim 14, further comprising a strap attached to a second end of the latch assembly that is opposite the first end, wherein the strap is attached to a bag flap and the steel plate is attached to a bag body.

16. The magnetic latching system of claim 15, further comprising at least one additional anchor bar that is parallel to the at least one anchor bar.

17. The magnetic latching system of claim 13, wherein the hook portion of the latch hook is located behind the latch pull and the latch magnet and in front of the locking member.

18. A magnetic latching system comprising:
a latch assembly having a latch magnet and a latch hook; and
an anchor bar assembly having a plurality of anchor bars that are attached to a ferromagnetic back plate;
wherein:
the latch magnet is configured to adhere to the ferromagnetic back plate using magnetic attraction and to create a lock-free soft closure;
the latch assembly is configured to engage with at least one of the plurality of anchor bars to form a locked, hard closure.

19. The magnetic latching system of claim 18, wherein the latch hook surrounds at least a portion of the at least one of the plurality of anchor bars.

20. The magnetic latching system of claim 19, further comprising a wedge-shaped locking member, wherein the anchor bar fits snuggly between the latch hook and the locking member.
